(19) United States
(12) Patent Application Publication
(10) Pub. No.: US 2005/0166495 A1
(43) Pub. Date: Aug. 4, 2005

(54) Sash for windows and doors equipped with anti-dewing hot wire

(76) Inventors: Soo Cho, Daejeon (KR); Cheol-Yong Jang, Daejeon (KR)

Correspondence Address: Peter T. Kwon;GWiPS, Kangnam, P.O. Box 2301, Seoul, 135-242, KR

(21) Appl. No.: 10/799,771

(22) Filed: Mar. 15, 2004

(30) Foreign Application Priority Data
Jan. 3, 2004 (KR) 2004-0000168

(51) Int. Cl. E06B 1/04

(52) U.S. Cl. 52/204.5; 52/204.1

(57) ABSTRACT

A sash for windows and doors equipped with an anti-dewing hot wire is provided. A double-layered glass, which is included an indoor sheet of glass and an outdoor sheet of glass spaced from each other by a spacer and filled with a desiccant material is fixedly installed on a sash frame. The frame, which is formed with a hollow tube with a reception groove in one surface and the double-layered glass sealed with sealant, comprises the hot wire, for generating heat by means of supplied power, attached along an edge of an inner surface of the indoor sheet of glass, a through hole for passing an electric wire electrically connected to the hot wire, formed through a designated portion of the spacer located on the lower portions of the indoor and outdoor sheets of glass of the double-layered glass, and a controller, which is connected to the electric wire for controlling the output of a power supply unit for supplying a driving voltage to the hot wire according to a user's manipulation signal, located in the hollow of a lower frame member of the sash frame. The sash effectively prevents the edge and inner surface of the indoor sheet of glass from dewing, and improves thermal insulation effects.

### BACKGROUND OF THE INVENTION

1. Field of the Invention

The present invention relates to a sash for windows and doors equipped with an anti-dewing hot wire, and more particularly to a sash for windows and doors equipped with an anti-dewing hot wire that effectively prevents an edge and an inner surface of an indoor sheet of glass from dewing and improves thermal insulation effects.

2. Related Prior Art

Generally, the double-layered glass is obtained by preparing two sheets of glass having the same standards, spacing the two sheets of glass from each other by a constant distance using a spacer, blowing dry air into the gap between the two sheets of glass, and then sealing the edges of the two sheets of glass with an organic material. Double-layered glass is employed in various places, such as the windows of buildings or dwellings requiring various functions and aesthetic effects and structures close to a road or an airport and requiring suppression of noise.

As described above, double-layered glass comprises the two sheets of glass having the same standards, the spacer interposed between the two sheets of glass, and a corner connector for fixing the spacer.

Here, the spacer is generally made of a metal such as aluminum, etc., and filled with a desiccant material such as silica gel, etc. The desiccant serves to remove moisture from the gap between the two sheets of glass, thereby preventing the inner surfaces of the sheets of glass from dewing.

Since windows and doors made with the above-described double-layered glass are designed such that the two sheets of glass are spaced from each other by a designated distance by means of the spacer, filled with a sealant along the edges thereof, and maintained in a dry state by the desiccant filling the spacer, the sash for such windows and doors has thermal insulation and noise-suppressing effects through a sealed air layer between the two sheets of glass.

However, in the conventional sash for windows and doors provided with double-layered glass, dewing is first generated on an edge of the indoor sheet of glass of the double-layered glass due to the temperature difference between the inside of a room and the outside and the heat conductivity of the spacer, and is then transferred to an inner surface of the sheet glass.

Particularly, in the case that the inner surface of the sheet glass is dewed, it is impossible to artificially remove the dewing from the sheet glass, thereby deteriorating the thermal insulation capacity of the double-layered glass.

There has been proposed an anti-dewing apparatus for solving the above problem, filed in the Korean Intellectual Property Office and assigned Utility Model Registration No. 20-0302255 by the present applicant(s). As shown in FIGS. 1, 2a and 2b, the anti-dewing apparatus comprises a sash frame 705, fixed to a wall, surrounding the circumference of a conventional sliding window or simple window and including upper, lower and side frames 751, a case 701 provided with an inlet 711 formed on a front surface thereof for allowing air to be introduced thereinto, and an outlet 712 formed on an upper surface thereof for allowing air to be discharged therefrom, a motor 714 located in the case 701 and controlled in terms of operation speed according to a user's manipulation, and an air blowing fan 713 connected to the motor 714 for forcibly blowing air onto the surface of the window.

The outlet 712 is provided with a sloping sidewall 715 and air directing grills 712a. A heater 716 is interposed between the air-directing grills 712a and the air-blowing fan 713. The inlet 711 is provided with guide grills 711a.

The above-described conventional anti-dewing apparatus blows indoor or outdoor air or air heated by the heater 714 onto the indoor surface of the window, thereby preventing the window from dewing or removing the dew generated on the surface of the window. However, with the use of the conventional anti-dewing apparatus, it is difficult to prevent the inner surface of the window from dewing. Thus, in order to effectively prevent the window from dewing, a plurality of the anti-dewing apparatuses is installed in the window, thereby increasing maintenance costs. In the case that only one anti-dewing apparatus is installed in the window, the load on the anti-dewing apparatus is increased. Further, the operation of the air-blowing fan creates noise and vibrations that shake the window, thereby amplifying noise. Moreover, since bacteria are easily propagated in the conventional anti-dewing apparatus, the anti-dewing apparatus must be periodically cleaned in order to provide clean air, thereby causing inconvenience to consumers.

### SUMMARY OF THE INVENTION

Therefore, the present invention has been made in view of the above problems, and it is an object of the present invention to provide a sash for windows and doors provided with an anti-dewing hot wire, which prevents front and inner surfaces of an indoor glass sheet from dewing in winter, improves thermal insulation effects so that the energy required for heating a room is minimized, protects an electric wire connected to the hot wire, and prevents current from flowing throughout the sash by means of an electrically insulated passage for the electric wire.

It is another object of the present invention to provide a sash for windows and doors provided with an anti-dewing hot wire, which controls the amount of heat generated by the hot wire according to the surface temperature of an indoor sheet of glass so as to improve the energy efficiency ratio, and allows the hot wire to generate heat using a power supply source provided in the sash.

In accordance with the present invention, the above and other objects can be accomplished by the provision of a sash for windows and doors provided with an anti-dewing hot wire, in which a double-layered glass, including an indoor sheet of glass and an outdoor sheet of glass spaced from each other by a spacer filled with a desiccant and sealed around the edges with sealant, is fixedly installed on a sash frame including a plurality of frame members, each of which is provided with a reception groove formed in one surface thereof and a hollow formed therein,, comprising: the hot wire, for generating heat by means of supplied power, attached along an edge of the inner surface of the indoor sheet of the double-layered glass; a through hole, formed through a designated portion of the spacer located on lower portions of the indoor and outdoor sheets of the double-layered glass, for passing an electric wire that is electrically connected to the hot wire; and a controller located in the hollow of the lower member of the sash frame, which is connected to the electric wire for controlling the output of a power supply unit for supplying a driving voltage to the hot wire according to a user's manipulation signal.

Preferably, the through hole may include an insulating guide unit including a guide hole for protecting and supporting the electric wire, and an insulating grommet provided around the outer circumference of the guide hole for insulating the electric wire from the surface of the spacer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional anti-dewing apparatus.

FIG. 2a is a cross-sectional view of the conventional anti-dewing apparatus of FIG. 1.

FIG. 2b is a longitudinal-sectional view of the conventional anti-dewing apparatus of FIG. 1.

FIG. 3 is a partially exploded perspective view of a sash for double-paned windows and doors provided with an anti-dewing hot wire in accordance with one embodiment of the present invention.

FIG. 4 is an enlarged view of the sash for double-paned windows and doors provided with the anti-dewing hot wire in accordance with one embodiment of the present invention; and

FIG. 5 is a schematic view illustrating a power supply state of a sash for double-paned windows and doors provided with an anti-dewing hot wire in accordance with another embodiment of the present invention.

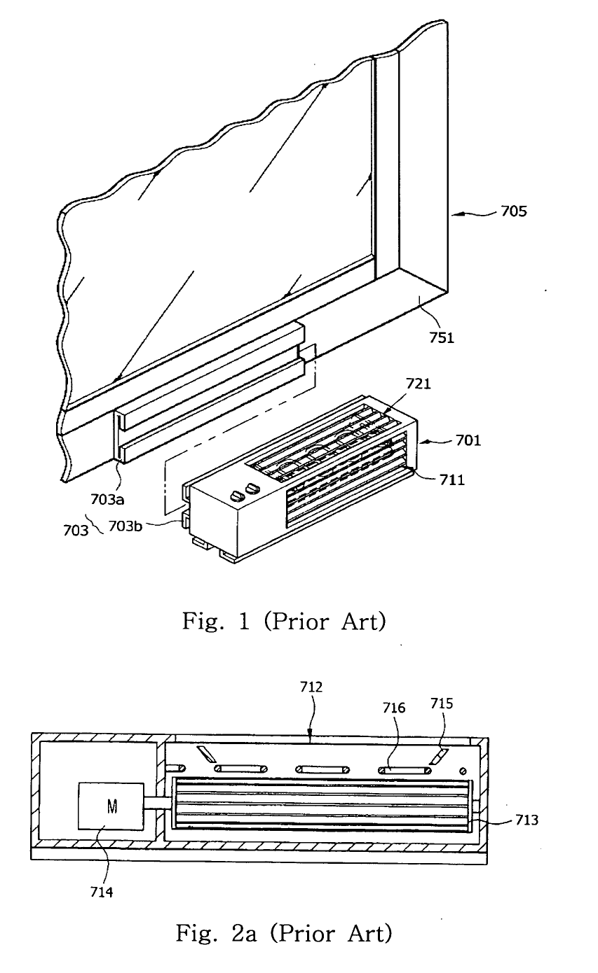

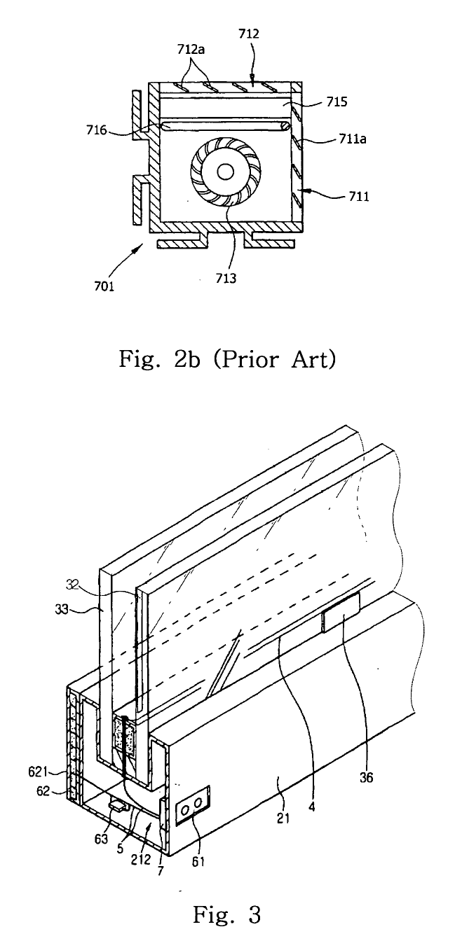

### DETAILED DESCRIPTION OF THE PREFERRED EMBODIMENTS

Now, preferred embodiments of the present invention will be described in detail with reference to the annexed drawings.

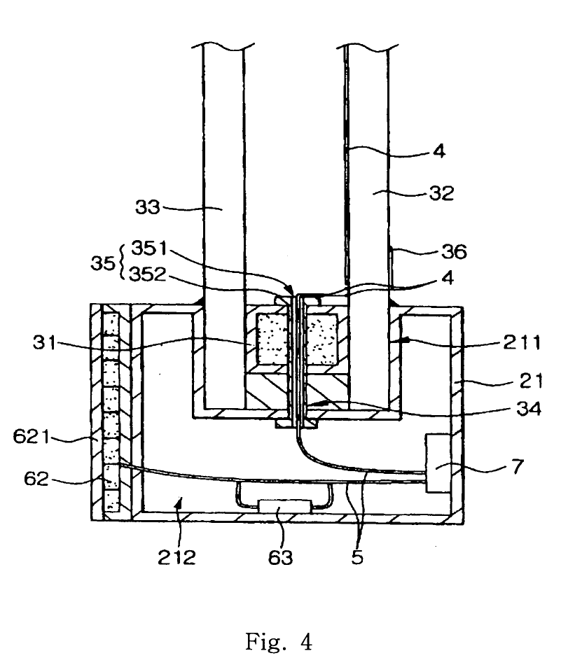

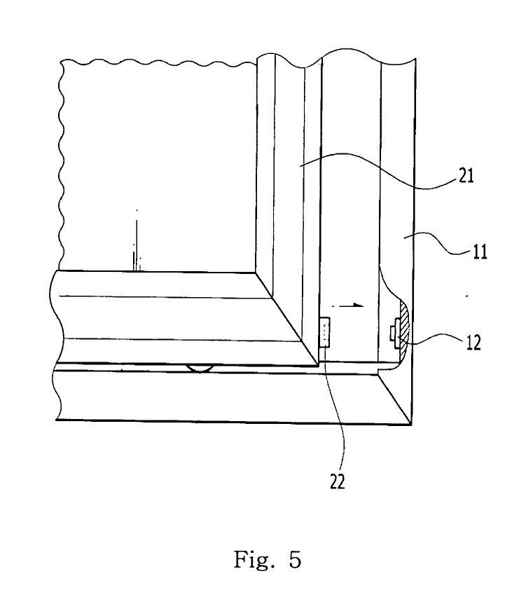

As shown in FIGS. 3 and 4, a sash for windows and doors provided with an anti-dewing apparatus having a hot wire in accordance with the present invention is configured such that a double-layered glass 3, including an indoor sheet of glass 32 and an outdoor sheet of glass 33 spaced from each other by a spacer 3 1 filled with a desiccant material, is fixedly installed on a sash frame (not shown) including a plurality of frame members 21, each of which is provided with a reception groove 211 formed in one surface thereof and a hollow 212 formed therein. Here, the double-layered glass 3, whose edge is sealed with a sealant, is fixedly inserted into the reception grooves 211 of the lower frame member 21 and held with an adhesive.

A hot wire 4 for generating heat by means of supplied power is attached along an edge of an inner surface of the indoor sheet of glass 32 of the double-layered glass 3.

A through hole 34 is formed through a designated portion of the spacer 31 located on lower portions of the indoor and outdoor sheets of glass 32 and 33 of the double-layered glass 3, for passing an electric wire 5 electrically connected to the hot wire 4 through the spacer 31.

A controller 7, which is connected to the electric wire 5 for controlling the output of a power supply unit for supplying a driving voltage to the hot wire 4 according to a user's manipulation signal, is located in the hollow 212 of the lower frame member 21 of the sash frame.

Further, the hot wire 4, as well known in the art, generates heat by means of electric current, and particularly prevents the window or door from dewing in the winter due to a very low level of electric current.

Preferably, the hot wire 4 is attached along the edge of the indoor sheet of glass 32 of the double-layered glass 3.

Since the edge of the indoor sheet of glass 32 is more susceptible to dewing than the center of the indoor sheet of glass 32, the hot wire 4, attached along the edge of the indoor sheet of glass 32, serves to more effectively prevent the inner surface of the indoor sheet of glass 32 from dewing.

Further, the hot wire 4, which is attached to the inner surface of the indoor sheet of glass 32 (the surface facing the airspace between the two panes of the double-layered glass 3) rather than the outer surface of the indoor sheet of glass 32, is more stable.

That is, in the case where the hot wire 4 is attached to the outer surface of the indoor sheet of glass 32 (the surface facing the room), the hot wire 4 can be scratched when the window or door is cleaned, thereby breaking the electrical circuit. Accordingly, it is preferable that the hot wire 4 is attached to the inner surface of the indoor sheet of glass 32 rather than the outer surface of the indoor sheet of glass 32.

The through hole 34 is formed through a designated portion of the spacer 31, and serves to pass the electric wire 5 through the spacer 31. The electric wire 5 is connected to the hot wire 4 for supplying driving power to the hot wire 4 attached to the inner surface of the indoor sheet of glass 32.

Preferably, an insulating guide unit 35 for insulating the electric wire 5 from the surface of the spacer 31 is provided around the inner circumference of the through hole 34.

That is, the insulating guide unit 35 includes a guide hole 351 for protecting and guiding the electric wire 5, and an insulating board 352 provided along an outer circumference of the guide hole 351 for insulating the electric wire 5 from the surface of the spacer 31. The outer circumference of the insulating guide unit 35 inserted into the through hole 34 is coated with Teflon, thereby insulated it from other elements.

Accordingly, when the double-layered glass 3 is manufactured, a continuous insulating jacket can be maintained on the electric wire 5 electrically connected to the hot wire 4 through the guide hole 351 of the insulating guide unit 35.

Particularly, the insulating board 352, having a disk shape, provided along the outer circumference of the guide hole 351 serves to prevent current from flowing to the sash frame through the electric wire 5 and the spacer 31.

The power supply unit (not shown) is connected to the electric wire 5 for supplying driving power to the hot wire 4, and located in the hollow 212 of the lower frame member 21 of the sash frame, i.e., the frame into which the spacer 31 provided with the through hole 34 is fixedly inserted.

In accordance with this embodiment of the present invention, the power supply unit includes a connector 61, which is located at one side of the sash frame, electrically connected to an input terminal of the controller 7, which will be described later, and corresponds to a terminal of a cable so that utility power is applied to the connector 61 through the cable.

In accordance with another embodiment of the present invention, the power supply unit includes a solar power module 62 for anti-dewing, including a plurality of solar cells, attached to an outer surface of the sash frame for supplying power to the hot wire 4.

Preferably, a protective cap 621, made of a transparent material, is installed on the front surface of the solar power module 62.

In the case that the above-described solar power module 62 is used, it is preferable that a charging unit 63, in which DC power input from the solar power module 62 is accumulated, is provided in the lower frame member 21 of the sash frame.

By using the charging unit 63, the solar power module 62 serves as a power supply source during the day, and the charging unit 63, which was charged during the day, serves as a power supply source during the night.

Particularly, since driving power is supplied to the hot wire 4 through the solar power module 62, serving as a self-contained power supply source attached to the sash frame, the sash for windows and doors in accordance with this embodiment of the present invention does not require a cable connected to an external utility power source, thereby maintaining a neat and tidy internal structure.

In accordance with yet another embodiment of the present invention, the power supply unit (not shown) supplies power to the hot wire 4, when the sash frame contacts a window frame 11 supporting the sash frame.

Here, a power input terminal 22 protrudes from a designated position in one of the upper frame members 21 of the sash frame, and a power output terminal 12 protrudes from a designated position on one surface of the window frame 11 corresponding to the sash frame member 21. The power output terminal 12 corresponds to the power input terminal 22, and is connected to the utility power source.

Accordingly, in the sash for windows and doors, designed as a sliding or casement type, provided with an anti-dewing hot wire in accordance with the above embodiment of the present invention, when the sash frame supporting the double-layered glass contacts the window frame supporting the sash frame, the power input terminal 22 formed on the sash frame is electrically connected to the power output terminal 12 formed on the window frame, thereby allowing the utility power to be supplied to the hot wire 4.

The controller 7 is located in the hollow 212 of the lower frame member 21 of the sash frame, and serves to control the output of power from the power supply unit to the hot wire 4 according to a user's manipulation signal. The controller 7 includes an input unit (not shown), into which the user's manipulation signal is input, and a transformer (not shown).

The input unit is a switch, which is provided at a designated position of an indoor frame of the window frame 11 for applying current to the hot wire 4 attached to the indoor sheet of glass 32.

Accordingly, in the case that a user wants to supply power to the hot wire 4, the switch is turned on, thus supplying driving power to the hot wire 4.

The transformer serves to convert power input from the power supply unit into rated current for the hot wire 4, and then to output the rated current to the hot wire 4. The structure of the transformer is well known to those skilled in the art, and a detailed description thereof will thus be omitted because it is considered to be unnecessary.

In the sash for windows and doors provided with the anti-dewing hot wire in accordance with the present invention, the transformer converts driving power input from the power supply unit according to a point contact signal of the switch, for example a turn-on signal of the switch, into rated current for the hot wire 4, and then outputs the rated current to the hot wire 4.

The hot wire 4, heated by the rated current, heats the inner surface of the indoor sheet of glass 32, thereby removing vapor condensation generated on the inner surface of the indoor sheet of glass 32. Further, the hot wire 4 heats the internal space between the two layers of glass, thereby improving thermal insulation effects between the inside and outside of a room and remarkably reducing the heating load for the room.

The sash for windows and doors provided with the anti-dewing hot wire in accordance with the present invention may further comprise a rated controller (not shown) for comparing a value input from a surface temperature sensor 36 sensing the surface temperature of the indoor sheet of glass 32 to a designated value, and outputting the rated current to the hot wire 4 based on the obtained result.

Here, the surface temperature sensor 36 is mechanically connected to the controller 7 through the hollow 212 of the lower frame member 21 of the sash frame.

Accordingly, in the sash for windows and doors provided with the anti-dewing hot wire in accordance with the present invention, in the case that the surface temperature of the indoor sheet of glass 32 sensed by the surface temperature sensor 36 is higher than the current dew point temperature of the atmosphere, which is already stored in the rated controller, the rated controller controls the power supply unit not to supply the driving power to the hot wire 4. On the other hand, in the case that the surface temperature of the indoor sheet of glass 32 sensed by the surface temperature sensor 36 is lower than the dew point temperature of the atmosphere, the rated controller controls the power supply unit to supply the driving power to the hot wire 4.

Here, the supplied driving power is converted into the rated current, as described above, and is then supplied to the hot wire 4.

As described above, in the case that the sash for windows and doors in accordance with the present invention comprises the rated controller, the sash does not require the above-described input unit. Further, in this case, the surface temperature sensor and the rated controller control the heat generation of the hot wire 4 according to the surface temperature of the indoor sheet of glass, thereby improving the energy efficiency ratio of the sash.

As apparent from the above description, the present invention provides a sash for windows and doors provided with an anti-dewing hot wire, in which a hot wire attached to an inner surface of a double-layered glass heats the indoor sheet of the double-layered glass to prevent the surface of the indoor sheet of glass from dewing in the winter, and heats in the space between the two layers of glass so as to improve thermal insulation effects between the inside and outside of a room.

The sash for windows and doors provided with the anti-dewing hot wire in accordance with the present invention comprises an insulating guide unit for insulating an electric wire connected to the hot wire from the surface of a conductive spacer, thereby preventing the current supplied to the hot wire from flowing to the sash frame through the spacer and minimizing the possibility of injuries due to an electric shock.

The sash for windows and doors provided with the anti-dewing hot wire in accordance with the present invention heats the indoor sheet of glass through the hot wire attached to the inner surface of the double-layered glass, thereby preventing the surface of the indoor sheet of glass from dewing in the winter. Furthermore, the sash for windows and doors provided with the anti-dewing hot wire in accordance with the present invention heats the space between the two layers of glass, thereby improving thermal insulation effects between the inside and outside of the room.

Moreover, the sash for windows and doors provided with the anti-dewing hot wire in accordance with the present invention insulates the electric wire connected to the hot wire from the surface of the conductive spacer by means of the insulating guide unit, thereby preventing the current supplied to the hot wire from flowing to the sash frame through the spacer and minimizing the possibility of injuries or accidents due to an electric shock so that the sash can be safely used.

The sash for windows and doors provided with the anti-dewing hot wire in accordance with the present invention controls heat generation in the hot wire according to the surface temperature of the indoor sheet of glass as monitored by a surface temperature sensor by means of a rated controller, thereby improving the energy efficiency ratio.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sash for windows and doors provided with an anti-dewing hot wire, in which a double-layered glass, including an indoor sheet of glass and an outdoor sheet of glass spaced from each other by a spacer filled with a desiccant, is fixedly installed on a sash frame including a plurality of frame members, each of which is provided with a reception groove formed in one surface thereof and a hollow formed therein, and an edge of the double-layered glass is sealed with a sealant, comprising:
a hot wire for generating heat by means of supplied power, attached along an edge of the inner surface of the indoor sheet of glass of the double-layered glass,
a through hole for passing an electric wire electrically connected to the hot wire, formed through a designated portion of the spacer located on lower portions of the indoor and outdoor sheets of glass of the double-layered glass, and
a controller, which is connected to the electric wire for controlling the output of a power supply unit for supplying a driving voltage to the hot wire according to a user's manipulation signal, located in the hollow of a lower frame of the sash frame.

2. The sash as set forth in claim 1, further comprising a surface temperature sensor for sensing the surface temperature of the indoor sheet of glass attached to the surface of the indoor sheet of glass, and a rated controller for comparing the surface temperature input from the surface temperature sensor to the current dew point temperature of the atmosphere, which is already stored in the rated controller, installed in the controller.

3. The sash as set forth in claim 1, wherein the power supply unit includes a connector located at one side of the sash frame, which is electrically connected to an input terminal of the controller and corresponds to a terminal of a cable so that utility power is applied to the connector through the cable.

4. The sash as set forth in claim 3, wherein the power supply unit includes a solar power module, including a plurality of photovoltaic cells, attached to an outer surface of the sash frame for supplying power to the hot wire, and a battery or charging unit, in which DC power input from the solar battery module is stored, installed in the hollow of the lower frame of the sash frame.

5. The sash as set forth in claim 4, wherein the power supply unit supplies power to the hot wire when the sash frame contacts a window frame supporting the sash frame, and a power input terminal protrudes from a designated position in the sash frame, and a power output terminal protrudes from a designated position in the window frame so that the power output terminal corresponds to the power input terminal and is connected to a utility power source.

6. The sash as set forth in claim 1, wherein the through hole includes an insulating guide unit for insulating the electric wire passing through the through hole from the surface of the spacer, provided on an inner surface of the through hole, and said insulating guide unit includes a guide hole for protecting and guiding the electric wire, and an insulating board provided around the outer circumference of the guide hole for insulating the electric wire from the surface of the spacer.
